(19) United States
(12) Patent Application Publication
(10) Pub. No.: US 2018/0249696 A1
(43) Pub. Date: Sep. 6, 2018

(54) REMOTE MONITORING OF LIVE CATCH RODENT TRAPS

(71) Applicant: WOODSTREAM CORPORATION, Lititz, PA (US)

(72) Inventors: Thomas J. DALY, JR., Lititz, PA (US); Todd M. Zielinski, Philadelphia, PA (US); Kalyan C. Jinnuri, Lancaster, PA (US); Daniel J. Wanninger, Springfield, PA (US); Peter KOZIAR, JR., Lititz, PA (US)

(73) Assignee: WOODSTREAM CORPORATION, Lititz, PA (US)

(21) Appl. No.: 15/909,225

(22) Filed: Mar. 1, 2018

Related U.S. Application Data
(60) Provisional application No. 62/466,124, filed on Mar. 2, 2017.

(51) Int. Cl. A01M 23/00; A01M 23/38; H04N 5/225; A01M 31/00

(52) U.S. Cl. CPC A01M 23/005; A01M 31/002; H04N 5/2257; A01M 23/38

(57) ABSTRACT

A live catch trap having a light-based sensor mounted therein and remote communication capability is provided. The light-based sensor may be a visual image device such as a CMOS or CCD camera that evaluates the status of the trap interior for the presence of insects and/or rodents. The camera may be activated to check the trap interior either periodically or in response to an event as detected by one or more sensors such as a motion detector, accelerometer, pressure sensor and/or temperature sensor. Alternatively, the trap may include a reflectivity sensor or a photo sensor including arrays of LEDs and photodiodes. The trap includes a microprocessor that evaluates the data collected by the light-based sensor to determine what type of activity has been sensed and then reports this information wirelessly to a remote user.

This application claims the priority of U.S. provisional application Ser. No. 62/466,124, filed Mar. 2, 2017.

### BACKGROUND OF THE INVENTION

### Field of the Invention

The present invention is related to the field of pest control and, more particularly, to a device and method for remotely monitoring rodent and insect activity in a live catch trap.

### Description of the Related Art

Live catch rodent traps such as the VICTOR® TIN CAT® shown in FIG. 1A have been used for decades as a passive solution to the problem of rodent control in both consumer and commercial/industrial applications. These traps must be periodically checked for pest activity and cleanliness, thus a monitoring process is often required in order to meet professional rodent control standards imposed by commercial and/or industrial facilities, or by third parties such as food safety auditors.

In addition, live catch traps and similar devices are typically outfitted with glue boards. These glue boards are not only effective in catching rodents but also add additional value as they render the rodent traps effective as insect monitoring devices as well, since both rodents and insects entering the trap become glued to the boards. When servicing by a technician is necessary, it is easy to clear these traps of any rodents, insects or other debris that may have entered the trap by simply removing and discarding the old glue board and replacing it with a new board. Nonetheless, checking the status of the traps is time consuming and may involve unnecessary time expenditure in the case that the trap does not require servicing.

Accordingly, in order to avoid wasted time examining traps that have not undergone any activity, a need exists for a device and method for accurately sensing rodent activity or presence in a live catch trap. A need also exists for such a device and method that is also capable of determining if there has been insect activity and, in the case of the device having a glue board, whether the glue board surface is too dirty to continue to be effective.

### SUMMARY OF THE INVENTION

In view of the foregoing, the present invention is directed to a live catch trap having a microprocessor and a light-based sensor mounted therein. The light-based sensor may be a visual image device, such as a CMOS or CCD camera, or may be a light detecting sensor such as a light reflectivity sensor or a photo sensor. The trap may be constructed with or without a glue board, although having the glue board is preferred as the value of the pest control provided by the trap is enhanced thereby. The trap further includes a wireless communication transmitter for sending wireless signals to a remote device.

In the case of a live catch trap having a visual image device such as a CMOS or CCD camera, the camera evaluates the status of the trap interior, either periodically or in response to an event as detected by a motion detector/accelerometer or a pressure and/or temperature sensor. Trap status includes the presence of insects and/or rodents and/or cleanliness. The microprocessor within the trap evaluates the data collected by the camera to determine which type of activity has been sensed and/or monitored through regular checking and then reports this information wirelessly to the cloud. Alternatively, the camera could simply take a picture for transmission to the user but this is not the preferred embodiment as transmission of a picture requires more bandwidth than the transmission of processed trap status data.

As embodied with a light reflectivity sensor as a light detecting sensor, the live catch trap includes a light transmitter and a receiver in communication with the microprocessor. The reflectivity sensor evaluates the amount of light transmitted by the transmitter that is received by the receiver, after being reflected off the floor or other surface of the trap, to determine the presence and extent of debris, insects and/or rodents. The condition of the trap in terms of cleanliness and/or pest presence is reported to the microprocessor which evaluates the data and then sends a wireless report to the user, preferably via the cloud.

Alternatively, the light detecting sensor in the live catch trap may be embodied as a photo sensor that includes photodiode and LED arrays arranged on opposite sides of the trap so that an entering rodent is positioned between the arrays. The LEDs are pulsed at a predetermined frequency which, in the absence of rodent presence, stimulates the photodiodes. If a rodent is present, however, the light is blocked in a predictable manner that can be detected and recognized by the microprocessor as a rodent, such as by use of an internal processing algorithm.

With the sensing and/or monitoring and communication transmission capabilities of the foregoing embodiments, the live catch traps as described herein enable users to check and manage their deployed traps remotely without having to physically inspect the traps.

Accordingly, it is an object of the present invention to provide a remote monitoring capability for live catch traps that are equipped with one or more light detecting or visual image sensors for detecting rodent activity and a communication transmitter for wirelessly reporting trap status data to a remote user. Unless otherwise specified, the terms “visual sensor” and “light-based sensor” are used interchangeably herein to refer to both light detecting sensors and visual image sensors and/or devices of the types and kinds disclosed herein and equivalents thereof in function and operation as such functional and operational equivalence would be understood by persons of skill in the art.

Another object of the present invention is to provide a device and method for monitoring rodent and/or insect activity in a live catch trap, and/or trap cleanliness, and for transmitting trap status information to a remote user, preferably via cloud computing, the live catch trap including a light-based sensor and a microprocessor configured to evaluate data from the light-based sensor.

A further object of the present invention is to provide a device and method for monitoring activity in a live catch trap in accordance with the preceding objects in which the light-based sensor is a visual image device or sensor that includes a CMOS or CCD camera inside or associated with the live catch trap.

Yet another object of the present invention is to provide a device and method for monitoring activity in a live catch trap in accordance with all but the immediately preceding object in which the light-based sensor is a light detecting sensor positioned inside or associated with the live catch trap, the light detecting sensor being one of a light reflectivity sensor or a photo sensor preferably including photodiode and LED arrays.

Still another object of the present invention is to provide a device and method for monitoring activity in a live catch trap in accordance with the preceding objects in which the live catch trap includes a microprocessor that evaluates the data received from the light-based sensor associated with the live catch trap and determines the type of activity that has been detected and/or monitored which is then transmitted with trap status data to the remote user.

A further object of the present invention is to provide a device and method for monitoring activity in a live catch trap in accordance with the preceding objects that enables a user to determine the trap content status and/or cleanliness of the trap on the basis of visual data feedback received from the trap before deciding whether or not it is necessary to send out a technician to service the trap.

A still further object of the present invention is to provide a device and method for monitoring activity in a live catch trap that is resistant to false triggers, such as due to insect or dirt infiltration, the trap being equipped with a light-based sensor for sensing rodent activity and a transmitter for wirelessly reporting trap status data to a remote user, the light-based sensor providing output data to a microprocessor that employs pattern recognition to evaluate the data and detect rodent presence.

Another object of the present invention is to provide a device and method for monitoring activity in a live catch trap in accordance with the preceding object in which the light-based sensor is a photo sensor that includes an array of light emitting diodes (LEDs) and a photodiode array on opposing sides of the trap, light transmitted by the LED array stimulating the photodiode array when the trap is empty while generating a predictable pattern in the photodiode array when the light is impeded by the presence of a rodent in the trap.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A shows a VICTOR® TIN CAT® live catch trap known in the prior art.

FIG. 1 is a perspective view of a live catch trap with the lid open to show a light-based sensor mounted on an inside surface of the trap body in accordance with the present invention.

FIG. 2 is a block diagram of a live trap having a CMOS or CCD camera in accordance with a first embodiment of the present invention.

FIG. 3 is a block diagram of a live trap having a reflectivity sensor and showing the glue board as optional in accordance with a second embodiment of the present invention.

FIG. 4A is a side view of a trap with a reflectivity sensor that includes a light transmitter and receiver in accordance with the second embodiment shown in FIG. 3.

FIG. 4B is a side view of a trap like that shown in FIG. 4A but as equipped with a glue board which forms the surface being evaluated by the reflectivity sensor.

FIG. 5 is a block diagram of a live trap having a photo sensor that includes a photodiode array with an associated LED array for stimulating the photodiode array in accordance with a third embodiment of the present invention.

FIG. 5A is a block diagram showing additional components found in the photo sensor shown in FIG. 5.

FIG. 5B is a block diagram showing the position of a rodent with respect to the LED and photodiode arrays of the photo sensor in the trap body of the live catch trap according to the third embodiment shown in FIG. 5.

FIG. 6 is a representative schematic of a photodiode amplifier and high pass filter like that included in the photo sensor shown in FIG. 5A.

FIG. 7 is a representative schematic of an LED array like that included in the photo sensor shown in FIG. 5A.

FIG. 8 is a flowchart of the method of monitoring a live catch trap and transmitting trap status information to a remote user in accordance with the present invention.

### DETAILED DESCRIPTION OF THE PREFERRED EMBODIMENTS

It is to be understood that the embodiments described herein are disclosed by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

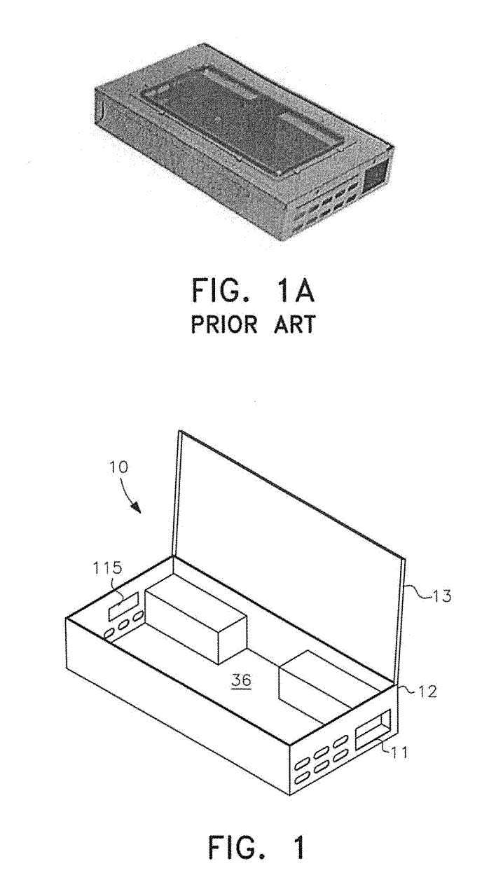

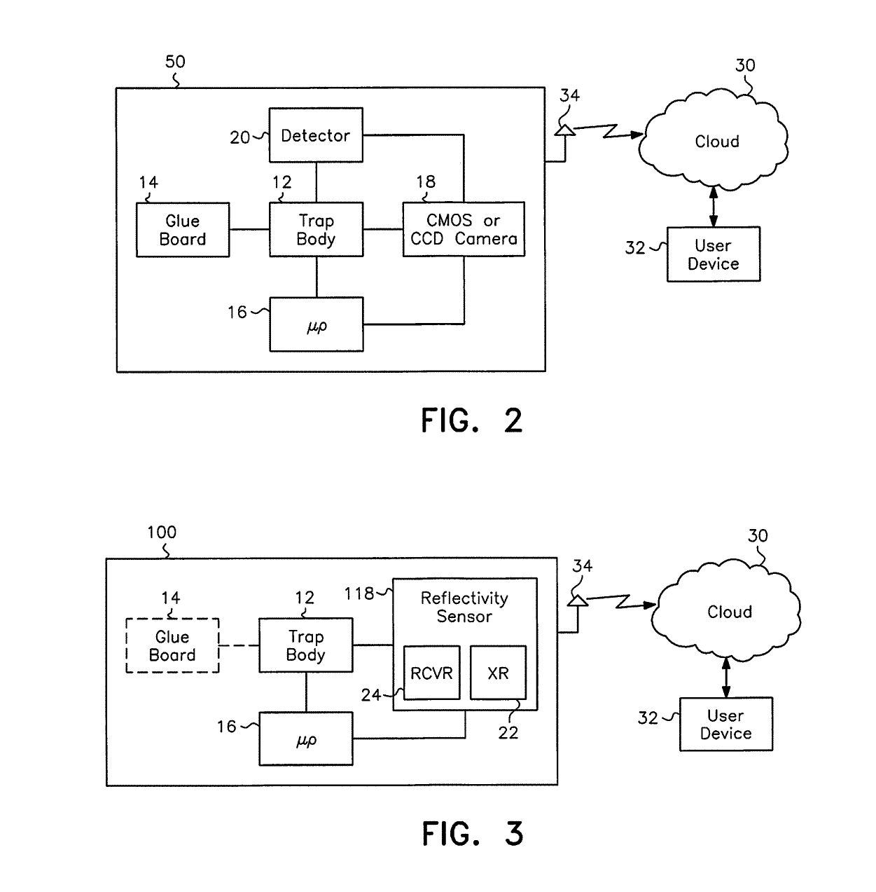

As shown in FIG. 1, the present invention is directed to a live catch trap generally designated by reference numeral 10 having a trap body 12 with a lid 13 and at least one entrance 11 through which a rodent enters the trap body 12. A light-based sensor 115 is mounted on an inner surface of the trap above the floor 36 of the trap. The floor 36 of the trap 10 preferably includes a glue board 14 (see FIG. 2).

According to a first embodiment shown in FIG. 2, the trap 50 includes a microprocessor 16 in communication with a visual image device such as a CMOS or CCD camera 18. The camera 18 evaluates the status of the trap interior, either periodically or in response to an event indicating rodent or insect activity as detected by a detector 20 and provides data to the microprocessor 16. The detector 20 may be a motion detector/accelerometer or a pressure and/or temperature sensor. The microprocessor 16 evaluates the data received from the camera 18 and determines the type of activity that has been detected which is then transmitted via a communication transmitter 34 to the smartphone, PC or like device of a remote user 32, preferably via the cloud 30. The user may thus be apprised of the trap condition and status without having to physically access the trap for hands-on evaluation.

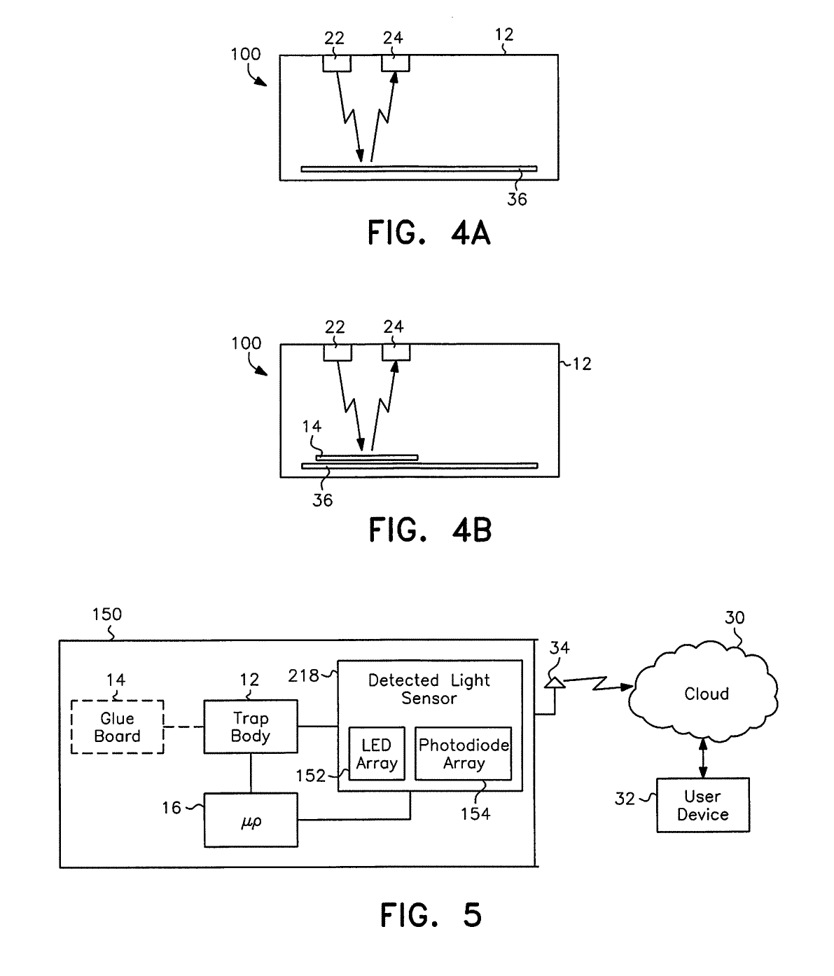

A second embodiment of a live catch trap 100 according to the present invention is shown in FIG. 3. As in the first embodiment, the trap 100 includes a trap body 12 that preferably includes a glue board 14 although, as in the first embodiment, inclusion of a glue board is not necessary. However, instead of a camera, the trap 100 includes a light detecting sensor embodied as a reflectivity sensor 118 comprised of a light transmitter 22 and a receiver 24 in communication with the microprocessor 16. The microprocesser 16 uses data from the reflectivity sensor 118 to evaluate the amount of light transmitted by the transmitter 22 that is reflected off an inner surface of the trap, such as the floor surface 36, and received by the receiver 24, as depicted in FIG. 4A, to determine the presence and extent of foreign bodies including debris, insects and/or rodents on the floor 36 of the trap. While the reflectivity sensor 118 is shown as being mounted on the upper surface of the trap, the sensor could alternatively be mounted on a side surface of the trap with another side surface and/or the floor of the trap serving as the reflective surface(s) to be evaluated. The reflectivity sensor may be any sensor for detecting light including visual light, IR light, UV light, and the like, alone or in combination. Whatever wavelength of light is being detected, the associated light or reflectivity sensor may be operated periodically, such as at set or variable intervals, or continuously to monitor trap status. In addition, the light or reflectivity sensor may be used in conjunction with an activity sensor like detector 20. When combined with an activity sensor, the trap may be configured to activate the light or reflectivity sensor in response to an activity sensor or detector input indicating the presence of a rodent or the occurrence of other activity of potential interest within or adjacent the trap.

If a glue board 14 is included, it may be positioned on the floor 36 as shown in FIG. 4B and serve as the surface being evaluated by the reflectivity sensor. As would be understood by persons of skill in the art, if a glue board is the surface being evaluated, the baseline used for the light that is reflected back would be different as compared to the light reflection baseline of the trap floor itself, i.e., the trap floor without a glue board. In either case, the condition of the trap in terms of cleanliness and/or pest presence is reported to the microprocessor 16 which evaluates the data and, using the communications transmitter 34, transmits the type of activity detected to the user 32, preferably via the cloud 30. The user may thus be apprised of the trap condition and status without having to physically access the trap for hands-on evaluation.

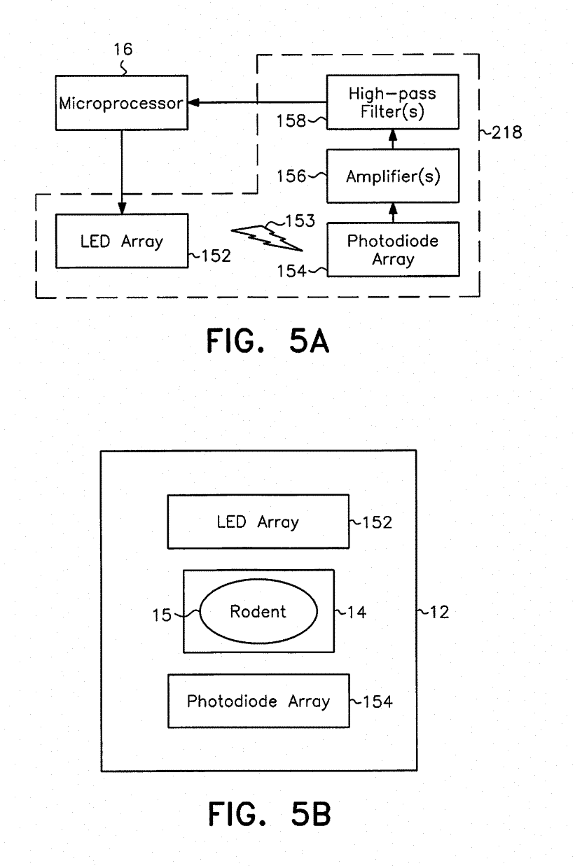

A third embodiment of a live catch trap 150, also using a light detecting sensor according to the present invention, is shown in FIGS. 5, 5A and 5B. As in the first and second embodiments, the trap 150 includes a trap body 12 that preferably includes a glue board 14 although, as in the previous embodiments, inclusion of a glue board is not necessary.

The light detecting sensor used to monitor rodent activity or presence in the trap 150 is a photo sensor 218 that includes an LED array 152 and a photodiode array 154 in communication with the microprocessor 16. As shown in FIG. 5A, the photo sensor 218 preferably includes at least one amplifier 156 and at least one high pass filter 158. If a glue board 14 is included, it may be advantageously positioned between the LED array 152 and the photodiode array 154 to substantially correspond with the likely position of a rodent 15 as shown in FIG. 5B.

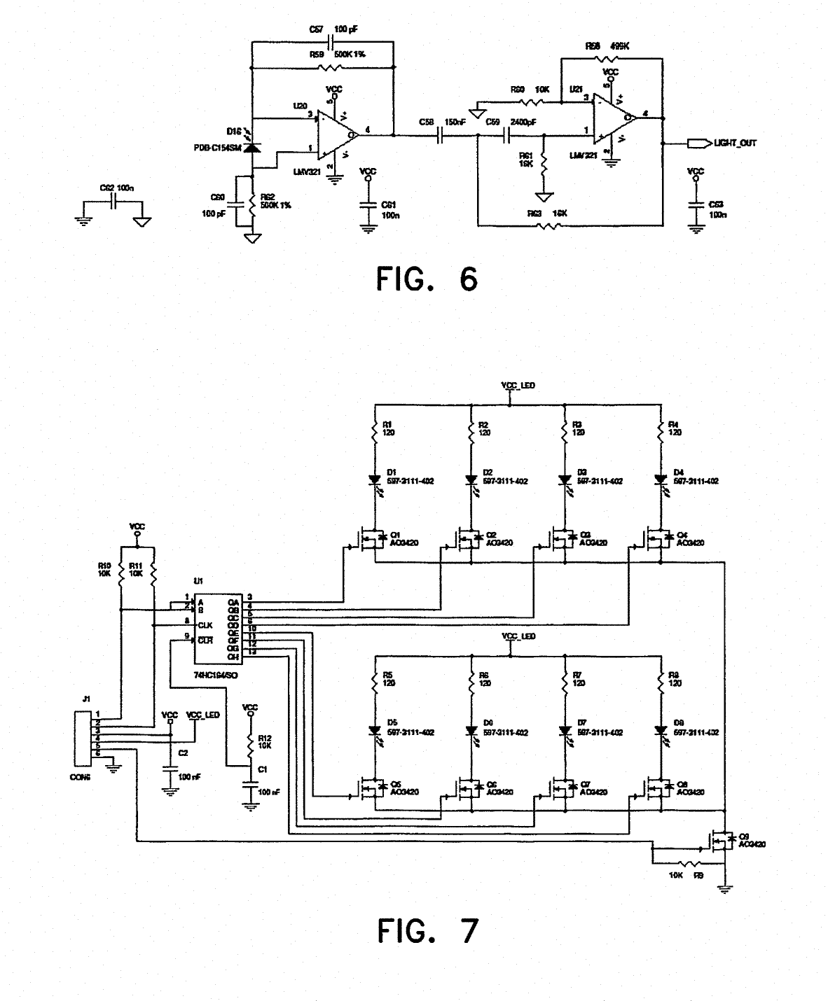

The light emitting diodes of the LED array 152 are configured to generate an output periodically and/or in response to an activity sensor. Preferably, the LEDs are pulsed with a waveform that has frequency components above 1 kilohertz, which is above frequencies commonly found in light sources such as LED or fluorescent fixtures. The light output 153 of the LED array stimulates the photodiode array 154 when no rodent 15 is present to block the light emitted by the LED array 152. Outputs from the photodiode array 154 are passed through the amplifier(s) 156 and conditioned via the high pass filter(s) 158 for ambient light elimination before being passed to the microprocessor 16. The high pass filter 158 preferably has a corner frequency of approximately 400 Hertz and a gain of 25×. A representative schematic of a photodiode amplifier and high pass filter circuit is shown in FIG. 6. A representative schematic of an LED array is shown in FIG. 7.

As rodents have a predictable profile, the microprocessor 16 is programmed with pattern recognition capability which is applied to the output of the high pass filter 158. When a rodent 15 is not present, the light from the LED array 152 stimulates the photodiode array 154 on the other side of the trap body 12 along most or all of its extent. Blockage of the light, as evaluated with pattern recognition software such as by using an internal processing algorithm or the like, however, is interpreted by the microprocessor 16 as indicating the presence of a rodent which may then be reported to the user 32, preferably via the cloud 30. Hence, as with the first two embodiments, the user may be apprised of trap condition and status without having to physically access the trap for hands-on evaluation.

To reduce the risk of false indications of rodent presence, the photodiode and LED arrays are preferably spaced vertically above the floor of the trap at a sufficient height to prevent the light beams from being interrupted by low-lying contamination such as insects or dust in the trap body. The number of LEDs and photodiodes in each array may be varied as would be understood by persons of skill in the art.

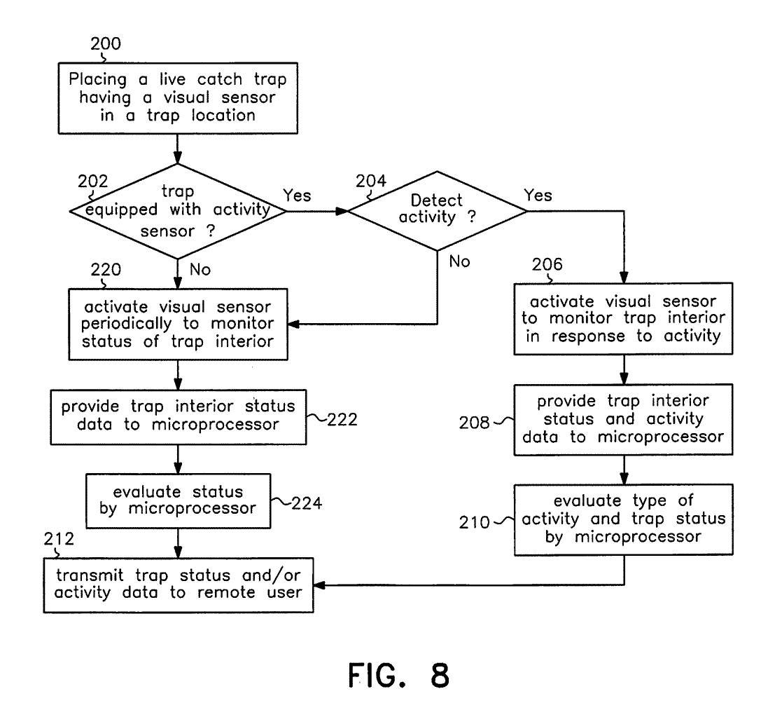

The present invention is further directed to a method of monitoring rodent and/or insect activity in live catch traps, and/or trap cleanliness, and for transmitting trap status information to a remote user via cloud computing as summarized in the flowchart of FIG. 8. According to the method, a trap having a light-based or visual sensor and transmission capabilities is placed in a trap location, step 200. If the trap is equipped with an activity sensor, step 202, upon detection of activity, step 204, the visual sensor is activated to monitor the trap interior, step 206. The trap activity and trap interior status data is provided to the microprocessor, step 208, which evaluates the type of activity, step 210. The trap status and activity data is then transmitted to a remote user, step 212.

If the trap does not have an activity sensor, step 202, or if the trap does have an activity sensor, step 202, but no activity is detected for a predetermined length of time, step 204, the visual sensor may be activated periodically, for example several times each hour, at least once a day, or at any determined interval, to monitor the status of the trap interior, step 220. The trap interior status data is provided to the microprocessor, step 222, which evaluates the status data, step 224. The status data is then transmitted to the remote user, step 212.

In the case of a visual image device such as a CMOS or CCD camera, evaluation of the status data, step 224, includes the microprocessor evaluating a picture taken by the camera to determine the type of trap activity shown in the picture, including whether a rodent is present, which may then be reported to the remote user.

In the case of a light reflectivity sensor, evaluation of the status data, step 224, includes the microprocessor evaluating the amount of light received by the receiver, after being transmitted by the light transmitter and reflected off an inner surface of the trap, to determine the presence of foreign bodies and/or a rodent in the trap for reporting to the remote user.

In the case of a photo sensor, evaluation of the status data, step 224, includes the microprocessor determining that a light pattern in the output received from the photodiode array indicates that at least part of the light emitted by the LED array was not received by the photodiode array. The microprocessor then uses pattern recognition to determine whether the light pattern of the photodiodes corresponds with a predicted pattern for a rodent.

With the live catch traps and method as described herein, unnecessary checking of traps that have not undergone any activity is avoided. When rodent activity has occurred, however, the trap both detects and evaluates the activity to provide the remote user with a report on the nature of the activity as well as the functional status of the trap in terms of its content which may include cleanliness. In addition, the ability to perform trap status checks at predetermined time intervals regardless of the presence or absence of activity, typically at least once a day but with variable time interval checking capability, and to transmit this information to a remote user, helps to ensure that the trap's functional readiness is efficiently maintained. The trap may also be configured to enable the remote user to request trap status information independently of trap activity.

The foregoing descriptions and drawings should be considered as illustrative only of the principles of the invention. The invention may be configured in a variety of shapes and sizes and numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A live catch trap for rodents comprising:
a trap body;
a light-based sensor associated with the trap body, the light-based sensor configured to monitor activity in the trap including rodent presence;
a microprocessor configured to evaluate data received from the light-based sensor to determine a type of trap activity; and
a wireless communication transmitter configured to send trap status information including the type of trap activity from the trap to a remote user.

2. The live catch trap as set forth in claim 1, wherein the light-based sensor is a visual image device.

3. The live catch trap as set forth in claim 2, wherein the visual image device is a CMOS or CCD camera.

4. The live catch trap as set forth in claim 3, further comprising an activity sensor associated with the trap body, said CMOS or CCD camera taking a picture in response to a trap activity event indicating rodent or insect presence as detected by the activity sensor.

5. The live catch trap as set forth in claim 4, wherein the activity sensor includes one or more sensors selected from the group consisting of a motion detector, an accelerometer, a pressure sensor and a temperature sensor.

6. The live catch trap as set forth in claim 4, wherein the trap body includes a glue board.

7. The live catch trap as set forth in claim 1, wherein the light-based sensor is a reflectivity sensor including a light transmitter and a receiver, the microprocessor being configured to evaluate data received from the reflectivity sensor indicating an amount of light transmitted by the light transmitter that is received by the receiver after being reflected off an inner surface of the trap body to determine a presence and extent of foreign bodies in the trap as at least part of the trap activity.

8. The live catch trap as set forth in claim 7, wherein the trap body includes a glue board.

9. The live catch trap as set forth in claim 1, wherein the light-based sensor is a photo sensor including an LED array and a photodiode array arranged on opposing sides of the trap body, light emitted by the LED array stimulating the photodiode array when the trap body is empty, said light being at least partly blocked by rodent presence in the trap body, said microprocessor receiving an output from the photodiode array and being configured to use pattern recognition to evaluate light blockage patterns in said output for correspondence with rodent presence.

10. The live catch trap as set forth in claim 9, wherein the photo sensor further includes an amplifier and a high pass filter for eliminating ambient light from the output provided to the microprocessor.

11. The live catch trap as set forth in claim 9, wherein the trap body includes a glue board.

12. A method for monitoring activity in a live catch trap, the method comprising the steps of:
providing a live catch trap having a trap body, a light-based sensor associated with the trap body, a microprocessor for receiving output data from the light-based sensor, and a wireless communication transmitter configured to send trap status information to a remote user;
monitoring activity in the trap using the light-based sensor;
evaluating, by the microprocessor, data received from the light-based sensor to determine a type of trap activity detected by the light-based sensor; and
transmitting trap status data including the type of trap activity from the trap to a remote user.

13. The method as set forth in claim 12, wherein the light-based sensor is a CMOS or CCD camera and the step of monitoring includes taking a picture of an interior of the trap body on a periodic basis, said step of evaluating including said microprocessor evaluating the picture to determine the type of trap activity shown in the picture and reporting the trap activity type to the remote user.

14. The method as set forth in claim 12, wherein the trap includes an activity sensor and the light-based sensor is a CMOS or CCD camera, the step of monitoring including taking a picture of an interior of the trap body in response to an event detected by the activity sensor, said step of evaluating including said microprocessor evaluating the picture to determine the type of trap activity shown in the picture and reporting the trap activity type to the remote user.

15. The method as set forth in claim 12, wherein the light-based sensor is a reflectivity sensor including a light transmitter and a receiver and the step of monitoring includes said receiver receiving light from said light transmitter after said light has been reflected off an inner surface of the trap body, said step of evaluating including said microprocessor evaluating an amount of light received by said receiver to determine a presence of foreign bodies in the trap and reporting the trap activity type to the remote user.

16. The method as set forth in claim 12, wherein the light-based sensor is a photo sensor including an LED array and a photodiode array positioned on opposing sides of the trap body and the step of monitoring includes said photodiode array receiving light emitted by said LED array and providing an output to the microprocessor, said step of evaluating including said microprocessor evaluating the output to determine if a rodent is present in the trap.

17. The method as set forth in claim 16, wherein said step of evaluating includes said microprocessor determining that a light pattern in the output indicates that at least part of the light emitted by said LED array was not received by said photodiode array and using pattern recognition capability to determine whether the light pattern corresponds with a predicted pattern for a rodent.

18. The method as set forth in claim 17, wherein the output from the photodiode array is passed through an amplifier and a high pass filter to eliminate ambient light before being sent to the microprocessor.
